(19) United States
(12) Patent Application Publication
(10) Pub. No.: US 2006/0132975 A1
(43) Pub. Date: Jun. 22, 2006

(54) Humidity control in a removable data cartridge

(75) Inventor: Yiping Ma, Layton, UT (US)

Correspondence Address: IOMEGA CORPORATION, PATENT DEPARTMENT, 10955 VISTA SORRENTO PARKWAY, SAN DIEGO, CA, 92130, US

(73) Assignee: Iomega Corporation

(21) Appl. No.: 11/019,332

(22) Filed: Dec. 21, 2004

(51) Int. Cl. G11B 23/03

(52) U.S. Cl. 360/133

(57) ABSTRACT

Removable cartridges employ a labyrinth-type seal design which features multiple seals for a very effective barrier to outside contaminants. The sealing mechanism of the cartridge is specifically designed so moisture and other contaminants are blocked from entering the cartridge, resulting in high resistance to corrosion and guarding against the potentially adverse effects of air borne particulate and infiltration of detrimental external gasses. Because no seal is perfect, the cartridge incorporates a charcoal desiccant inside each cartridge to provide additional protection from moisture, corrosion and out-gassing. The disk design also includes a robust recirculation filter on each cartridge to filter the air inside the cartridge each time the disk spins, effectively removing any airborne contaminants that make it past the cartridge seal.

### TECHNICAL FIELD

This invention relates to computer storage products, and more particularly to controlling relative humidity in removable data cartridges.

### BACKGROUND

Over the past twenty years, computer technology has evolved very rapidly. One aspect of this evolution has been a progressively growing demand for increased storage capacity in memory devices. In order to provide a high storage density at a reasonable cost, one of the most enduring techniques has been to provide a rotatable hard disk with a layer of magnetic material thereon, and a read/write head which is supported for movement adjacent the disk and can transfer information to and from the disk.

In an arrangement of this type, if airborne dust, smoke, vapors or other contaminants are present, they can be attracted to the disk by any electrostatic charge that may be present on the disk. Then, because the head is disposed closely adjacent the disk during normal operation, the contaminants can be transferred to and progressively build up on the head. Eventually, the buildup of contaminants will be sufficient to interfere with the interaction between the head and disk, thereby increasing the error rate until the device will not operate.

In order to avoid this problem, most hard disk drives have the disk and head disposed within a sealed enclosure, so that the disk and head are not exposed to whatever airborne contaminants may happen to be present externally of the enclosure. This approach works well where the entire hard disk drive device is permanently installed in a computer. In other types of systems, however, a hard disk is provided within a removable cartridge, and it is desirable that the cartridge not include the read/write head.

In this regard, there are advantages to placing a head stack assembly (HSA) and its support structure within the drive which receives the cartridge, rather than in the cartridge. For example, a typical user will have several removable cartridges for each drive. Thus, in terms of overall system cost, it is cheaper to provide one head stack assembly with support which is in the drive, rather than to provide several head stack assemblies with support which are each disposed in a respective one of the many cartridges used with the drive. However, in removable cartridges, there is a problem in regard to keeping the head clean.

More specifically, in order to permit the head from the drive to access the disk within the cartridge, the cartridge is not provided with a sealed enclosure of the type discussed above. Instead, the cartridge is provided with an opening through which the head of the drive can be inserted into the cartridge. In some cases, a movable shutter is provided in order to obstruct the opening when the cartridge is not in the drive. However, when the cartridge is in the drive, the shutter moves to an open position. Thus, regardless of whether or not a shutter is present, when the cartridge is in the drive, there is an opening which gives the head access to the interior of the cartridge, and which also necessarily gives ambient air access to the interior of the cartridge, along with any dust, smoke, vapor or other contaminants that are carried by the ambient air.

What is needed is a cartridge that can control the amount of environmental contaminants and humidity.

### SUMMARY

Removable cartridges employ a labyrinth-type seal design which features multiple seals for a very effective barrier to outside contaminants. The sealing mechanism of the cartridge is specifically designed so moisture and other contaminants are blocked from entering the cartridge, resulting in high resistance to corrosion and guarding against the potentially adverse effects of air borne particulate and infiltration of detrimental external gasses. Because no seal is perfect, the cartridge incorporates a charcoal desiccant inside each cartridge to provide additional protection from moisture, corrosion and out-gassing. The disk design also includes a robust recirculation filter on each cartridge to filter the air inside the cartridge each time the disk spins, effectively removing any airborne contaminants that make it past the cartridge seal.

### DESCRIPTION OF DRAWINGS

These and other features and advantages of the invention will become more apparent upon reading the following detailed description and upon reference to the accompanying drawings.

FIG. 1 diagrammatic central sectional view of an apparatus which is a removable information storage cartridge, and which embodies aspects of the present invention.

### DETAILED DESCRIPTION

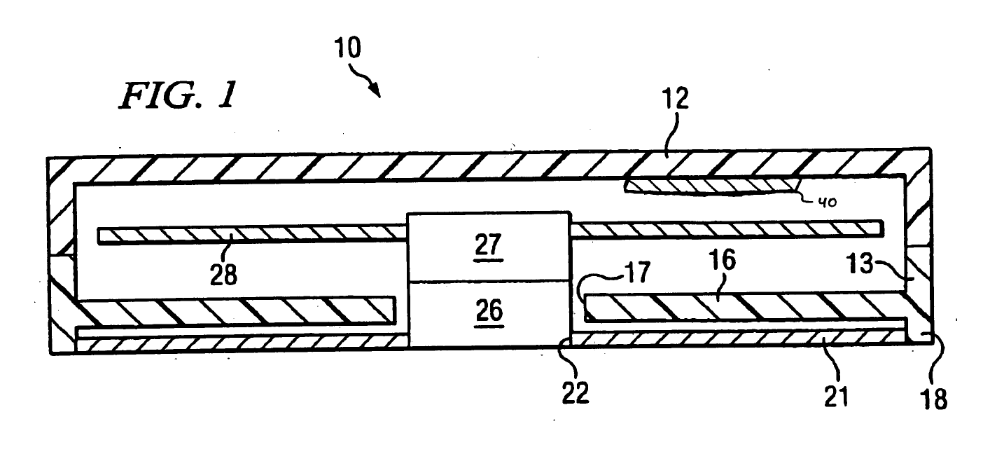

FIG. 1 is a diagrammatic central sectional view of an apparatus which is a removable information storage cartridge 10, and which embodies aspects of the present invention. The cartridge 10 has a housing which includes a top shell 12 and a bottom shell 13 that are fixedly coupled to each other. For example, the shells 12 and 13 may be coupled by not-illustrated screws, or in some other suitable manner. The shells 12 and 13 are each made of a dissipative plastic of a known type. However, the shells 12 and 13 could alternatively be made of a conductive plastic of a known type, or a conductive metal. The bottom shell 13 has a wall 16 with a central opening 17 through it. Further, the shell 13 has a circumferential projection 18, which extends downwardly from the peripheral edges of the wall 16.

An electrically conductive metal plate 21 has its peripheral edges fixedly secured in any suitable manner to the lower end of the circumferential projection 18. For example, the plate 21 can be secured to the projection 18 with a known epoxy adhesive, or by not-illustrated mechanical cooperation of the shell 13 and plate 21. The top surface of the plate 21 is spaced from the bottom surface of the wall 16, and the plate 21 has a vertical opening 22 through a central portion thereof. The opening 17 through the bottom shell 13 is slightly larger than the opening 22 through the plate 21. In the embodiment of FIG. 1, the plate 21 is made of aluminum, but it would alternatively be possible to make the plate from some other electrically conductive material.

An electric motor 26 has its lower end fixedly mounted in the opening 22 through the plate 21, for example by a known epoxy adhesive, or by not-illustrated mechanical cooperation between the motor 26 and plate 21. The motor 26 includes a hub 27, which is rotated by the motor 26. A circular disk 28 is fixedly mounted on the hub 27, so as to be concentric with the axis of rotation of the hub 27. It will be noted that the openings 17 and 22 are aligned with each other, and are aligned with the axis of the disk 28. The disk 28 is effectively disposed within a chamber in the housing of the cartridge 10. The disk 28 includes a rigid substrate which is not separately depicted, and which is made of a known material such as aluminum, glass, plastic, or embossed plastic. The disk 28 also includes, on one or both sides of the substrate, a layer of a known magnetic material which can store digital information.

The cartridge 10 can be removably inserted into a drive of a known type, which is not illustrated and described in detail. The drive has a not-illustrated movable arm, which supports a not-illustrated magnetic read/write head. The magnetic head can write information to and/or read information from the magnetic layer provided on one side of the disk 28. The housing defined by the shells 12 and 13 has a not-illustrated opening, which allows the magnetic head and a part of the arm to enter the housing when the cartridge 10 is inserted into the drive, so that the magnetic head can access the disk 28. Due to the presence of this opening, it is possible for airborne contaminants such dust and smoke particles to enter the cartridge 10.

To control the relative humidity and eliminate corrosive gasses, an absorbent filter 40 is included in the housing of the cartridge 10. The absorbent filter can be made with materials such as activated carbon, impregnated activated carbon, silica gel, desiccants, or other ingredients known in the art to control humidity and eliminate corrosive gases. The materials that may be used in the filter are well known in the art. The absorbent filter 40 can be integrated into the removable cartridge in the form of an absorbent breather filter, an absorbent recirculation filter, or an absorbent pouch. The absorbent filter 40 as shown in FIG. 1 is affixed to the housing on the top shell 12 using a pressure sensitive adhesive. As the motor 26 spins the disk 28, the air circulates inside the housing and interfaces with the absorbent filter 40. As the air interfaces with the absorbent filter 40, any extra humidity or contaminants present in the air is removed by the filter 40.

Numerous variations and modifications of the invention will become readily apparent to those skilled in the art. Accordingly, the invention may be embodied in other specific forms without departing from its spirit or essential characteristics.

What is claimed is:

1. A method for controlling humidity in a removable information storage cartridge comprising:
including an absorbent filter in the housing of a cartridge; and
removing excess humidity from the air in the housing with the absorbent filter.

2. The method of claim 1, further comprising spinning a disk within the housing to circulate the air around the absorbent filter.

3. The method of claim 1, wherein the absorbent filter includes a desiccant.

4. The method of claim 3, wherein the desiccant is silica gel.

5. The method of claim 1, wherein the absorbent filter includes activated carbon.

6. The method of claim 1, further comprising attaching the absorbent filter to a housing of the cartridge using pressure sensitive adhesive.

7. A removable information storage cartridge comprising:
a housing defining an internal chamber;
information storage media disposed within the internal chamber;
an absorbent filter within the internal chamber.

8. The removable information storage cartridge of claim 7, further comprising a motor attached to the information storage media, wherein the motor rotates the information storage media within the internal chamber to circulate the air about the absorbent filter.

9. The removable information storage cartridge of claim 7, wherein the absorbent filter includes a desiccant.

10. The removable information storage cartridge of claim 7, wherein the desiccant is silica gel.

11. The removable information storage cartridge of claim 7, wherein the absorbent filter includes activated carbon.

12. The removable information storage cartridge of claim 7, wherein the absorbent filter is attached to the housing using pressure sensitive adhesive.
